(19) United States
(12) Patent Application Publication
(10) Pub. No.: US 2021/0139757 A1
(43) Pub. Date: May 13, 2021

(54) LOW-VOID POLYURETHANES

(71) Applicant: SCG CHEMICALS CO., LTD., Bangsue (TH)

(72) Inventors: Wiwat Pornwannachai, Bangkok (TH); Aunchana Wangriya, Bangkok (TH)

(73) Assignee: SCG CHEMICALS CO., LTD., Bangsue (TH)

(21) Appl. No.: 16/764,993

(22) PCT Filed: Nov. 21, 2018
(86) PCT No.: PCT/IB2018/059193

§ 371 Date: May 18, 2020

Related U.S. Application Data
(60) Provisional application No. 62/589,606, filed on Nov. 22, 2017.

(51) Int. Cl. C09J 175/04; C09D 175/04; C08K 3/22; C08K 3/04; C08G 18/76; C08G 18/30; C08G 18/10

(52) U.S. Cl. CPC C09J 175/04; C09D 175/04; C08K 3/22; C08K 3/04; C08G 18/7671; C08G 18/307; C08G 2170/20; C08K 2201/006; C08K 2201/005; C08K 2003/2296; C08K 2003/2227; C08K 2003/2217; C08G 18/10

(57) ABSTRACT

Disclosed is a moisture-cured polyurethane adhesive containing 0.5% to 40% by weight of layered double hydroxide particles dispersed in the polyurethane. Also disclosed is a curable resin composition including a polyurethane prepolymer with an isocyanate component and a polyol component. The polyurethane prepolymer is curable with moisture and contains layered double oxide particles dispersed in the prepolymer in an amount from 0.5% to 40% by weight of the composition. A method of making a polyurethane adhesive is also disclosed.

### RELATED APPLICATIONS

This application claims the benefit under 35 U.S.C. § 371 as a U.S. National Application of application no. PCT/IB2018/059193 titled LOW-VOID POLYURETHANES, filed on Nov. 21, 2018, which claims benefit of U.S. Provisional Application No. 62/589,606, filed Nov. 22, 2017, both of which are hereby incorporated herein by reference in their entirety.

### FIELD OF THE DISCLOSURE

The present disclosure relates generally to urethane polymers and inorganic additives for urethane polymers. Specifically, the present disclosure is directed to moisture cured polyurethanes with reduced voids and a method of manufacturing the same.

### BACKGROUND

Polyurethanes are polymers produced in a chemical reaction between an isocyanate compound and a polyol compound. The first step of this reaction results in the chemical linking of the two molecules, resulting in a reactive alcohol (HO⁻) on one side and a reactive isocyanate (NCO⁻) on the other side. These groups further react with other monomers to form a larger, longer molecule. This is a rapid process that yields high molecular weight materials even at room temperature. Isocyanate groups can react with water to form a urea linkage and carbon dioxide gas. Polyurethanes typically contain other functional groups in the molecule including esters, ethers, amides, or urea groups. Polyurethanes are a versatile polymer used in building insulation, surface coatings, adhesives, solid plastics, and apparel.

### SUMMARY

In one aspect, a moisture-curable polyurethane prepolymer is provided, the polyurethane prepolymer comprising 0.5% to 40% by weight of layered double oxide particles dispersed in the prepolymer. The prepolymer can be a reactive polyurethane hot-melt, can be substantially free of CO₂ and/or substantially free of gaseous CO₂. A polyurethane polymer can be produced from the prepolymer, and the polyurethane polymer can be essentially free of CO₂ or gaseous CO₂. The layered double oxide particles can be produced by calcining layered double hydroxides having a chemical formula of [M^{z+}₁₋ₓM^{′y+}ₓ(OH)₂]^{a+}(Xⁿ⁻)_{a/n}·bH₂0 where M and M′ are charged metal cations and M is different from M′, z=1 or 2 or mixture thereof, y=3 or 4, 0<x<0.9, b=0-10, and X′ is an anion with n>0. M^{z+} can be selected from Mg²⁺, Zn²⁺, Li¹⁺, and mixtures thereof and M^{′y+} is Al³⁺. The molar ratio of Mg²⁺ to Al³⁺ can be less than 2:1, from 1.8:1 to 2.2:1, from 2.8:1 to 3.2:1 or from 3.8:1 to 4.2:1. The layered double oxide particles can comprise from 1% to 20% by weight of the composition and can have an average primary particle size of less than 1 μm, from 50 nm to 1 μm or from 50 nm to 500 nm. The layered double oxide particles can have a BET surface area of at least 100 m²/g or greater than 200 m²/g and an OAN greater than 100 cm³/100 g. The prepolymer can include carbon black in an amount from 0.01% to 30% by weight or less than 20% by weight. The layered double oxide particles can have a D₅₀ particle size from 0.5 μm to 10 μm.

The cured polyurethane polymer can exhibit a thermal conductivity of less than 1.5 W/(m·K), less than 1.3 W/(m·K), less than 1.0 W/(m·K), less than 0.5 W/(m·K), less than 0.3 W/(m·K) or less than 0.2 W/(m·K). The layered double oxide particles can exhibit a platelet shape or a rosette shape, can exhibit at least partial phase change to layered double hydroxide particles during moisture curing, can possess a CO₂ capture capacity, and the CO₂ capture capacity of the layered double oxide particles can be directly proportional to a number of Mg²⁺ in the layered double oxide particles or to the calcination temperature the layered double hydroxide particles undergo to produce the layered double oxide particles. The layered double oxide particles can have pores, and the CO₂ capture capacity of the layered double oxide particles can depend on volume of the pores of the layered double oxide particles. The volume of the pores of the layered double oxide particles can be directly proportional to the calcination temperature layered double hydroxide particles undergo to produce the layered double oxide particles, and the CO₂ capture capacity of the layered double oxide particles can be directly proportional to the volume of the pores of the layered double oxide particles. The CO₂ capture capacity of the layered double oxide particles can be at least two-fold more than the CO₂ capture capacity of an equivalent mass of carbon black. The CO₂ capture capacity of the layered double oxide particles can be directly proportional to a number of Li⁺ ions in the layered double oxide particles. The cured polyurethane can exhibit a tensile strength by ASTM D412 of from 3 MPa to 5 MPa. Its mechanical strength can be proportional to the percentage weight of the layered double oxide particles dispersed in the polyurethane. The cured polyurethane can be a sealant, an adhesive, an automotive product, a glazing adhesive or a semi-structural adhesive. The cured polyurethane can possess an elastic modulus of at least 1, at least 2, at least 2.5 or at least 3 MPa at 25° C. and may have an electrical conductivity of not greater than 5E-10 S/cm, not greater than 2E-10 S/cm or not greater than 2E-11 S/cm. The cured polyurethane can exhibit an optical transmittance value of at least 1%, at least 10%, at least 20%, at least 50%, or at least 85% for light having a wavelength from 400 nm to 700 nm. It can include no voids with a diameter greater than 0.2 mm and may have 0.5% to 40% by weight of layered double hydroxide particles dispersed therein. The curable prepolymer can comprise free [NCO-] from 2% to 5% by weight. The moisture-curable polyurethane may include layered double oxide particles having a chemical formula of [M^{z+}₁₋ₓM^{′y+}ₓO]Xⁿ⁻_{x/n}, where M and M′ are charged metal cations and M is different from M′, Xⁿ⁻ is an anion with n>0, z=1 or 2 or a mixture thereof, y=3 or 4; and 0<x<0.9. M^{z+} is selected from Mg²⁺, Zn²⁺, Li¹⁺, and mixtures thereof and M^{′y+} is Al³⁺. The molar ratio of Mg²⁺ to A³⁺ can be less than 2:1, from 1.8:1 to 2.2:1, from 2.8:1 to 3.2:1 or from 3.8:1 to 4.2:1. The layered double hydroxide particles can be selected from hydrotalcite, LiMgAl—CO₃, or Mg₂Al-stearate.

In another aspect, a method of making a polyurethane prepolymer is provided, the method comprising combining an isocyanate component and a polyol component to form a prepolymer composition and admixing layered double oxide particles in an amount from 0.5% to 40% by weight of the composition. The method can include exposing the composition to moisture to form a crosslinked polyurethane, the crosslinked polyurethane being substantially free of CO₂ and having an electrical conductivity of less than 5E-10 S/cm. The layered double oxide particles can have a BET surface area of at least 100 m²/g and can comprise from 1% to 20% by weight of the composition. The layered double oxide particles can be produced by calcining layered double hydroxides having a chemical formula of [M^{z+}₁₋ₓM^{′y+}ₓ(OH)₂]^{a+}(Xⁿ⁻)_{a/n}·bH₂0 where M and M′ are charged metal cations and M is different from M′, z=1 or 2 or mixture thereof, y=3 or 4, 0<x<0.9, b=0-10, and X′ is an anion with n>0. M^{z+} can be selected from Mg²⁺, Zn²⁺, Li¹⁺, and mixtures thereof and M^{′y+} is Al³⁺. The molar ratio of Mg²⁺ to Al³⁺ can be less than 2:1, from 1.8:1 to 2.2:1, from 2.8:1 to 3.2:1 or from 3.8:1 to 4.2:1. The layered double oxide particles can be produced by calcining layered double hydroxide particles and the LDH particles can be selected from hydrotalcite, LiMgAl—CO₃, or Mg₂Al-stearate. The LDO particles can have an OAN greater than 100 cm³/100 g and can be agglomerated and have an average agglomerate size of from 2 μm to 10 μm. The calcining of the LDH particles can be performed at a temperature from 300° C. to 500° C. The method of making the prepolymer can include dispersing a carbon black into the prepolymer composition in an amount up to 20% by weight. The method can include wetting the layered double hydroxide particles with water to provide wet LDHs and contacting the wet LDHs with a solvent miscible with water and having a solvent polarity from 3.8 to 9, thereby increasing a value of an oil absorption number. The LDO particles can have a chemical formula of [M^{z+}₁₋ₓ M′^{y+}ₓO]^{x+}Xⁿ⁻_{x/n}, where M and M′ are charged metal cations and M is different from M′, Xⁿ⁻ is an anion, z=1 or 2 or a mixture thereof, y=3 or 4 and 0<x<0.9. M^{z+} can be selected from Mg²⁺, Zn²⁺, Li¹⁺, and mixtures thereof and M^{′y+} is Al³⁺. The molar ratio of Mg²⁺ to Al³⁺ can be less than 2:1, from 1.8:1 to 2.2:1, from 2.8:1 to 3.2:1 or from 3.8:1 to 4.2:1. The method can include cross-linking to polymerize the material into an adhesive, a coating or a structural part.

In another aspect, a moisture-curable polyurethane hot-melt prepolymer is provided, the prepolymer comprising 0.5% to 40% by weight of layered double oxide particles dispersed in the polyurethane hot-melt. The prepolymer can include a diisocyanate component and a polyol component, the diisocyanate component comprises one or more of aromatic diisocyanates, aliphatic diisocyanates, araliphatic diisocyanates, cycloaliphatic diisocyanates, and mixtures thereof, and a ratio of the diisocyanate component to the polyol component is such that a molar ratio of NCO to OH is greater than 1. The prepolymer can be used to produce a polyurethane that is substantially free of CO₂, substantially free of gaseous CO₂ or essentially free of CO₂. The prepolymer can include LDO particles produced by calcining layered double hydroxides having a chemical formula chemical formula of [M^{z+}₁₋ₓM^{′y+}ₓ(OH)₂]^{a+}(Xⁿ⁻)ₐ.bH₂0 where M and M′ are charged metal cations and M is different from M′, z=1 or 2 or mixture thereof, y=3 or 4, 0<x<0.9, b=0-10, and Xⁿ⁻ is an anion with n>0. M^{z+} can be selected from Mg²⁺, Zn²⁺, Li¹⁺, and mixtures thereof and M^{′y+} is Al³⁺. The molar ratio of Mg²⁺ to Al³⁺ can be less than 2:1, from 1.8:1 to 2.2:1, from 2.8:1 to 3.2:1 or from 3.8:1 to 4.2:1. The layered double oxide particles can comprise from 1% to 20% by weight of the composition and can have an average primary particle size of less than 1 μm, from 50 nm to 1 μm or from 50 nm to 500 nm. The layered double oxide particles can have a BET surface area of at least 100 m²/g or greater than 200 m²/g and an OAN greater than 100 cm³/100 g. The prepolymer can include carbon black in an amount from 0.01% to 30% by weight or less than 20% by weight. The layered double oxide particles can have a D50 particle size from 0.5 μm to 10 μm. The cured polyurethane polymer can exhibit a thermal conductivity of less than 1.5 W/(m·K), less than 1.3 W/(m·K), less than 1.0 W/(m·K), less than 0.5 W/(m·K), less than 0.3 W/(m·K) or less than 0.2 W/(m K). The layered double oxide particles can exhibit a platelet shape or a rosette shape, can exhibit at least partial phase change to layered double hydroxide particles during moisture curing, can possess a CO₂ capture capacity, and the CO₂ capture capacity of the layered double oxide particles can be directly proportional to a number of Mg²⁺ in the layered double oxide particles or to the calcination temperature the layered double hydroxide particles undergo to produce the layered double oxide particles. The layered double oxide particles can have pores, and the CO₂ capture capacity of the layered double oxide particles can depend on volume of the pores of the layered double oxide particles. The volume of the pores of the layered double oxide particles can be directly proportional to the calcination temperature layered double hydroxide particles undergo to produce the layered double oxide particles, and the CO₂ capture capacity of the layered double oxide particles can be directly proportional to the volume of the pores of the layered double oxide particles. The CO₂ capture capacity of the layered double oxide particles can be at least two-fold more than the CO₂ capture capacity of an equivalent mass of carbon black. The CO₂ capture capacity of the layered double oxide particles can be directly proportional to a number of Li⁺ ions in the layered double oxide particles. The method of making the prepolymer can include dispersing a carbon black into the prepolymer composition in an amount up to 20% by weight. The prepolymer can be used to make a sealant, an adhesive, an automotive product, a coating, a glazing adhesive or a semi-structural adhesive by cross-linking. The cured polyurethane can be an adhesive having a tensile strength by ISO 37 of greater than 3 MPa. The mechanical strength of the adhesive can be proportional to the percentage weight of the layered double oxide particles dispersed in the polyurethane resin. The LDO particles can have a chemical formula of [M^{z+}₁₋ₓ M^{′y+}ₓ O]^{x+}Xⁿ⁻ x/n, where M and M′ are charged metal cations and M is different from M′, Xⁿ⁻ is an anion, z=1 or 2 or a mixture thereof, y=3 or 4 and 0<x<0.9. M^{z+} can be selected from Mg²⁺, Zn²⁺, Li¹⁺, and mixtures thereof and M^{′y+} is Al³⁺. The molar ratio of Mg²⁺ to Al³⁺ can be less than 2:1, from 1.8:1 to 2.2:1, from 2.8:1 to 3.2:1 or from 3.8:1 to 4.2:1.

### BRIEF DESCRIPTION OF THE DRAWINGS

FIG. 1 is a flowchart showing a method of making a polyurethane adhesive in accordance with embodiments of the present disclosure.

FIGS. 2A-2J show samples of cured polyurethane adhesive prepared from various compositions of the present disclosure, where different LDO compositions and loadings are evaluated.

FIGS. 3A-3F show additional samples of cured polyurethane adhesive prepared from various compositions of the present disclosure, where LDO loadings and cation ratios in the LDO are evaluated.

FIG. 4 shows a representative sample of cured polyurethane adhesive prepared according to a conventional method.

FIG. 5 shows XRD spectra of representative samples of an LDO, an LDH, a cured polyurethane, and an LDO incorporated cured polyurethane adhesive.

FIG. 6 shows CO₂ capture capacities of representative samples of LDOs produced by calcining LDHs having three different chemical formulae. The three LDHs have different amounts of Mg²⁺ ions in them.

FIG. 7 shows CO₂ capture capacities of representative samples of LDOs produced by calcining an LDH at three different temperatures.

FIG. 8 shows CO₂ capture capacities of representative samples of LDOs produced by calcining LDHs having different amounts of lithium ion loadings.

FIG. 9 shows CO₂ capture capacities of representative samples of an LDO produced by calcining an LDH at 400° C., and two commercially available carbon blacks namely, Printex 3 and Nerox 600.

FIG. 10 shows mechanical properties, measured in terms of tensile strength and tensile stress, of representative samples of cured polyurethane adhesives with varying amounts of LDO and carbon black loadings.

FIG. 11 shows hysteresis rheology curves of representative samples of two cured polyurethane adhesives—one loaded with a carbon black (10% by weight) and an LDO (5% by weight), and the another loaded only with the carbon black (10% by weight). The LDO was produced by calcining an LDH namely Mg₂AlO, and then loaded to the polyurethane prepolymer prior to curing.

FIG. 12 shows sag resistant properties of representative samples of two cured polyurethane adhesives—one loaded with a carbon black (10% by weight) and an LDO (5% by weight), and the another loaded only with the carbon black (10% by weight). The LDO was produced by calcining an LDH namely Mg₂AlO, and then loaded to the polyurethane prepolymer prior to curing.

The figures depict various embodiments of the present disclosure for purposes of illustration only. Numerous variations, configurations, and other embodiments will be apparent from the following detailed discussion.

### DETAILED DESCRIPTION

The present disclosure relates to the use of layered double oxides to consume carbon dioxide as it is produced during the curing of a polyurethane polymer, such as a polyurethane adhesive. One aspect of the present disclosure is directed to a moisture-curable polyurethane prepolymer containing a polyurethane prepolymer and 0.5% to 40% by weight of layered double oxide particles dispersed in the polyurethane prepolymer. In some embodiments, the reactive prepolymer can be a reactive polyurethane hot-melt. Another aspect of the present disclosure is directed to polyurethane products having few or no voids. Another aspect of the present disclosure is directed to a moisture-cured polyurethane containing 0.5% to 40% by weight of layered double oxide particles or layered double hydroxide particles dispersed in the polyurethane. Also disclosed is a curable resin composition including a polyurethane prepolymer with an isocyanate component and a polyol component, where the polyurethane prepolymer is curable with moisture and contains layered double oxide particles dispersed in the prepolymer in an amount from 0.5% to 40% by weight of the composition. A method of making polyurethane prepolymer is also disclosed, the method including dispersing layered double oxide particles in a prepolymer composition. The polymer can be, for example, an adhesive, a structural part, a coating or an automotive product.

### General Overview

Polyurethanes are polymers that have a molecular backbone containing carbamate groups (—NHCO2) and can contain functional groups that result in a crosslinked structure. Polyurethanes are produced by reacting a diisocyanate (OCN—R—NCO) with a polyol. Diisocyanates are reactive compounds that include two isocyanate groups (—N═C═O). Both aromatic and aliphatic diisocyanates can be used. Examples of diisocyanates employed in polyurethane production include methylene diphenyl diisocyanate (MDI), toluene diisocyanate (TDI), hexamethylene diisocyanate (HDI) and polymeric isocyanate (PMDI). Other diisocyanates can provide harder polyurethane elastomers with a higher softening temperature. These include, for example, 1,5-naphthalene diisocyanate and bitolylene diisocyanate (TODI). Polyols are compounds containing multiple alcohol groups (—OH). Common polyols include polyethers (PPG, PTMEG), polyesters, and polycaprolacotnes. The reaction between a polyol and an isocyanate is rapid and yields high molecular weight materials even at room temperature. The chemical equation below illustrates an example of a reaction between a diisocyanate and a diol to produce a polyurethane.

[chemical structure]

In automotive applications, adhesives have been increasingly used in the assembly process to bond parts together, especially in new models of vehicles where composites are used. These non-metal parts cannot be assembled using traditional welding methods. Polyurethane resin can provide adhesives with superior mechanical, temperature and chemical properties. Polyurethanes predominantly used in adhesives are usually available in the form of a prepolymer synthesized by the reaction of polyols and excess isocyanate, resulting in NCO-capped prepolymer.

Similar to other thermoset resins, these NCO-capped urethane prepolymers require an activator and/or catalyst to initiate crosslinking to become a cured polymer. This polymerization process is also known as curing. In NCO-capped polyurethane prepolymers, water (moisture) is required to activate the curing reaction between isocyanate groups, resulting in carbon dioxide (CO₂) as a by-product. However, other catalysts such as bis(morpholinoethyl)ether, dibutyltin, dilaurate, and tertiary amine, can also be used for activating the polymerization of polyols and isocyanate.

As an alternative to polyurethane prepolymers, reactive polyurethane hot-melt can also be used to produce polyurethane polymers such as polyurethane adhesives, structural components and coatings. Some advantages of polyurethane hot-melts lie in the possibility of applying them hot with relatively low viscosities, and obtaining high initial strength after a relatively short time. Polyurethane hot-melts possess an ability to develop cohesive strength (initial strength) very rapidly on cooling, enabling any joined parts, for example, to be handled immediately after joining. The initial strength of the material comes from the sharp and continuous viscosity increase resulting from the drop in temperature. Also, a recrystallization effect can lead to a sudden increase in strength.

The reactive polyurethane hot-melt may include a diisocyanate component and a polyol component, wherein the polyol component is generally at a high concentration and the first-order or second-order transition (Tm or Tg) temperatures of the polyol component are also relatively high. Typically, in a reactive polyurethane hot-melt, the ratio of the diisocyanate component and the polyol component is such that a molar ratio of NCO to OH is greater than 1.

Similar to polyurethane prepolymers, the actual curing of a reactive polyurethane hot-melt, i.e. the crosslinking reaction of the components with one another, occurs over hours to days through reaction of the isocyanate groups with water from the surroundings, or from the substrates which have been glued together, to form polyurea, resulting in CO₂ as a by-product. However, regardless of the precursor materials of an adhesive, carbon dioxide formation is disfavored in polymers such as adhesives because it gases off, resulting in bubbles or voids that cause a poor appearance and reduced strength-voids behave as a stress concentration point.

Carbon black can be used to adsorb CO₂ and reduce the formation of voids in the cured polyurethane. However, carbon black is electro-conductive and therefore can render the resulting polyurethane adhesive conductive, especially when carbon black is used at a high loading as is typically required to sufficiently capture carbon dioxide. It is generally understood that polyurethanes can have a maximum carbon black loading of 20% by weight and still retain adequate electrical resistance as a non-conductive adhesive. In automotive applications, conductivity is typically disfavored because it leads to the possibility of corrosion of the vehicle's bonded parts via electron transfer between two parts of the vehicle.

In view of the disadvantages of current technology, a need exists for low-void or no-void polyurethane products such as adhesives, having low electrical conductivity, for example, below 5E-10 S/cm. To address this need, the present disclosure relates to the use of layered double oxides (LDOs) or layered double hydroxides (LDHs) as an additive in prepolymers and/or polymers to sequester carbon dioxide and eliminate voids in the cured polyurethane product without increasing the electrical conductivity of the material. In one embodiment, electrical conductivity is measured according to ASTM D2739 version 1997, “Standard Test Method for Volume Resistivity of Conductive Adhesives.” The low-void polyurethanes can also be used as sealants or as a direct glazing adhesive or as a semi-structural adhesive among many other uses.

Accordingly, the present disclosure is directed to low-void polyurethanes, polyurethane adhesives, LDH and LDO fillers, polyurethane prepolymers, and master batch compositions. In one embodiment, a polyurethane is produced with the addition of layered double oxides (LDOs). LDOs consume or adsorb carbon dioxide during the curing step, preventing the formation of gaseous bubbles that form voids. Layered double oxides (LDOs) can be made by transforming layered double hydroxides (LDHs) to their oxide form, such as by calcining. Calcining can be performed, for example, at a temperature range of 200 to 1000° C. In various embodiments, calcining takes place at a temperature up to 450° C., 500° C., 550° C. or 600° C. During calcining, H₂O and anions can be removed from between layers of the LDH and also from the surface of the LDH, thereby changing the structure of the material. However, LDOs may still have moisture content of, for example, less than 2% or preferably less than 1% or more preferably less than 0.5%.

Without being bound by any particular theory, it is believed that LDOs combine with water (moisture) in the presence of anionic species to yield LDHs. The water molecules may react with the oxide to form the hydroxide and/or may be adsorbed within the layers of the particle. Any available anionic species may be intercalated into the layers to balance the electrical charges in the structure and will therefore result in an LDH. The transition from LDO to LDH may be gradual and an LDO particle may be partially reduced before it is entirely converted to an LDH particle. Furthermore, different portions of a particle may be at different stages of oxidation/reduction.

LDHs are a class of inorganic ionic solids having a layered structure with a general layer sequence [AcBZAcB]ₙ, where c represents layers of metal cations, A and B are layers of hydroxide anions (HO⁻), and Z represents layers of other anions and neutral molecules such as water. Layered double hydroxides (LDHs) occur naturally as minerals and as the result of corrosion of metal objects. However, LDHs and LDOs can also be synthesized via chemical processes. In one class of LDHs, cationic layer c includes monovalent or divalent cations M^{z+} and divalent or trivalent cations M^{′y+} with a formula represented by [M^{z+}₁₋ₓM^{′y+}ₓ(OH)₂]^{a+}(Xⁿ⁻)_{a/n}.bH₂O, where
Xⁿ⁻ is an intercalating anion;
M^{z+} is an alkali metal, an alkaline earth metal or a transition metal and can specifically be a monovalent or divalent cation selected from one or more of Li¹⁺, Ca²⁺, Mg²⁺, Mn²⁺, Fe²⁺, Co²⁺, Ni²⁺, Cu²⁺ and Zn²⁺; and
M^{′y+} can be a divalent or trivalent metal cation, such as, for example, Al³⁺.

In some embodiments, 0<x<0.9, 0.2<x<0.33 or 0.5<x<0.9. M′ may be the same or a different element as M in some instances. When M and M′ are the same, they are in different oxidation states, such as Fe²⁺ and Fe³⁺. In various embodiments, b can be greater than 0 and less than 10. In specific embodiments, M^{z+} is Mg²⁺, M^{′y+} is Al³⁺ and x can be, 0.2, 0.25, 0.33 or 0.4.

In some embodiments, the layered double hydroxide (LDH) is one or more of hydrotalcite (Mg₆Al₂(OH)₁₆[CO₃].4H₂O), LiMgAl—CO₃, or Mg₂Al-stearate. In some embodiments, the divalent cation M²⁺ is Mg²⁺, M^{′3+} is Al³⁺. Synthetic hydrotalcite is available from Sigma-Aldrich in powder form with particle size distributions of <1 μm and <5 μm. A related product, magnesium aluminate (MgAl₂O₄), is also available as a nanopowder with <50 nm particle size.

In one embodiment of LDOs, the layered double oxide particles can be represented by a chemical formula [M^{z+}₁₋ₓ M^{′y+}ₓ O]^{x+}Xⁿ⁻_{x/n}, where

M and M′ are charged metal cations and M is different from M′;

Xⁿ⁻ is an anion;

z=1 or 2 or a mixture thereof;

y=3 or 4; and

0<x<0.9.

In another embodiment of LDOs, the layered double oxide particles can be represented by a chemical formula [M^{z+}₁₋ₓ M^{′y+}ₓ O]^{x+}, where
M and M′ are charged metal cations and M is different from M′;
z=1 or 2 or a mixture thereof;
y=3 or 4; and
0<x<0.9.

In some embodiments, 0<x<0.9, 0.2≤x≤0.33 or 0.5<x<0.9. M′ may be the same element as M or M′ may be a different element than M. When M and M′ are the same, they are in different oxidation states, such as Fe²⁺ and Fe³⁺. In specific embodiments, M^{z+} is Mg²⁺, M^{′y+} is Al³⁺ and x can be, 0.2, 0.25, 0.33 or 0.4.

In another embodiment of LDOs, the layered double oxide particles can be represented by a chemical formula -[M²⁺₁₋ₓ M³⁺ₓO]^{x+}Aⁿ⁻_{x/n}, where M²⁺ is a divalent metal ion, M³⁺ is a trivalent metal ion, Aⁿ⁻ is an interlayer anion, and x is a fraction of M²⁺ or x is M²⁺/(M²⁺+M³⁺). In some embodiments, M²⁺ is Mg²⁺, M³⁺ is Al³⁺, and x can be 0.2, 0.25, 0.33 or 0.4. In some embodiments, M²⁺ can be Fe²⁺ and M³⁺ can be Fe³⁺.

In another embodiment of LDOs, the layered double oxide particles can be represented by a chemical formula -[M²⁺₁₋ₓ M³⁺ₓO]^{x+}, where M²⁺ is a divalent metal ion, M³⁺ is a trivalent metal ion.

In some other embodiments, an LDO can also be defined in terms of its ability to capture CO₂. In one embodiment, the CO₂ capture capacity of an LDO can lie in the range of 0 to 1.5 millimoles of CO₂ per gram of the LDO.

Structure and Methods

Embodiments of the present disclosure include a moisture-cured polyurethane adhesive, curable resins, and other polyurethane compositions containing layered double oxide (LDO) and/or layered double hydroxide (LDH) particles dispersed in the composition. The LDO and/or LDH particles capture carbon dioxide produced during the moisture cure of the polyurethane adhesive, preventing the carbon dioxide from forming bubbles and providing a cured polyurethane with fewer and smaller voids. In some embodiments, the cured polyurethane is virtually free of voids as observed with the naked eye. A moisture-cured polyurethane adhesive contains from 0.1% to 40% by weight of LDO and/or LDH particles dispersed in the polyurethane adhesive in accordance with an embodiment of the present disclosure. Other loadings are used in various embodiments, including 0.1% to 1%, 0.1% to 3%, 0.1% to 5%, 0.2% to 1%, 0.2% to 2%, 0.2% to 5%, 0.5% to 1%, 0.5% to 5%, 0.5% to 10%, 1% to 5%, 1% to 10%, 1% to 20%, 2% to 10%, 2% to 20%, 3% to 7%, 3% to 10%, 3% to 20%, 5% to 20%, 10% to 20%, 10% to 35%, 10% to 30%, 10% to 25%, 10% to 20%, 10% to 15%, 15% to 40%, 15% to 35%, 15% to 30%, 15% to 25%, 15% to 20%, 20% to 40%, 20% to 35%, 20% to 25%, 8% to 12%, 12% to 14%, 14% to 16%, 16% to 18%, 18% to 20%, 20% to 22%, 22% to 24%, 24% to 26%, 26% to 28%, 28% to 30%, 30% to 32%, 32% to 34%, 34% to 36%, 36% to 38%, and 38% to 40%, 15% to 35%, 20% to 30%, 15% to 30%, 15% to 25%, and 15% to 20%, by weight.

Another embodiment is a moisture-curable resin composition that includes a polyurethane prepolymer and layered double oxides (LDOs) dispersed in the prepolymer. In one embodiment, the prepolymer includes an isocyanate component and a polyol component, where the isocyanate component is provided in an excess, on an equivalents basis, to the polyol component. The polyol component can include one or more polyols. For example, the polyol component can be a blend of polyols. In some embodiments, the LDOs are dispersed in the polyol component. LDOs can be included in an amount from 0.1% to 40% by weight of the composition, including the LDO loadings discussed above with reference to the polyurethane adhesive.

It is believed that LDO particles can remove carbon dioxide via two mechanisms. One of these mechanisms is by physical adsorption of the CO₂ molecules on the crystalline surface of the LDO particle. The other is via consumption of carbon dioxide by, for example, hydroxylation and/or hydration of LDO in the presence of H₂O and CO₂. In some embodiments, LDOs are added to the composition in an amount to provide at least a stoichiometric excess of oxygen per mole of CO₂ produced upon curing the polyurethane prepolymer to the crosslinked polyurethane adhesive in accordance with the present disclosure. This can be calculated by knowing the —NCO number for the polymer system. For example, the amount of LDO can be selected to provide just enough oxygen to consume or adsorb all carbon dioxide produced during curing while leaving a small or negligible excess of LDOs in the cured polyurethane. In other embodiments, LDOs are added in an amount to provide a significant stochiometric excess of oxygen per mole of CO₂. Such an embodiment is useful to ensure that all of the CO₂ produced during curing is consumed by the LDO. If there is a one to one ratio between LDO active sites and CO₂ molecules, all LDO active sites will not necessarily be proximal to CO₂ molecules during the limited reaction time during which voids are formed. In other cases, LDO particles may not be evenly distributed throughout the composition, resulting in insufficient quantities of LDOs in isolated areas of the composition. In still other instances, some LDO particles may have a large size that renders some sites on the particle inaccessible to CO₂ during the polymerization reaction. In these example instances, the composition in theory has sufficient LDO capacity to consume CO₂ generated during the curing process, but reaction kinetics, the effectiveness of particle distribution, or other factors may limit the consumption of CO₂. To compensate for these inefficiencies, a stoichiometric excess of LDOs can be used. This means that at least some of the LDO particles will not be fully utilized and that, for example, greater than 10%, greater than 20% or greater than 50% of the total CO₂ capacity of the LDO particles in the system may be left unreacted or underutilized. Thus, in some embodiments, LDOs are added to provide more than 120%, 150%, 200%, 300%, 400% or 500% of the amount of LDOs required to provide one mole of oxygen per mole of CO₂ (or per equivalents of —NCO) produced during the cure process. In these cases, the cross-linked polymer may include a mixture of LDO and LDH particles as well as LDO/LDH particles that lie in the spectrum between LDO and LDH.

LDO particles can be obtained in one set of embodiments by calcining layered double hydroxides at a temperature between 300° C. and 400° C., between 300° C. and 500° C. or between 300° C. and 600° C. The calcining temperature is selected to be sufficient to result in a phase transition of LDH to LDO. In some embodiments, the calcining temperature is not greater than 600° C. For example, LDH particles are calcined at 400° C. for five hours to obtain LDO, the oxide form of LDH. Calcining removes water in the composition and oxidizes the LDH to LDO.

In an embodiment, the LDH particles have the following chemical formula before calcining:

[M^{z+}₁₋ₓM^{′y+}x(OH)₂]^{a+}(Xⁿ⁻)_{a/n}.bH₂O (1)

In formula 1 above, M and M′ are charged metal cations, where M is different from M′. In various embodiments of the LDH, z can be 1, 2, or a mixture thereof; y=3 or 4; 0<x<0.9; b is from 0-10; and Xⁿ⁻ is an anion with n>0. For instance, b can be greater than or equal to 0, 1, 2, 3, 4, 5, 6, 7, 8, 9 or 10, or b can be less than or equal to 10, 9, 8, 7, 6, 5, 4, 3, 2, 1 or 0. Calcining causes a phase transformation from LDH to LDO and removes water from the structure so that b=0 or essentially 0. Examples of acceptable LDH materials include hydrotalcite, LiMgAl—CO₃, or Mg₂Al-stearate.

Cations can be selected from Al³⁺, Mg²⁺, Zn²⁺, Li¹⁺, and mixtures thereof. In various embodiments, cations M and M′ are selected as Mg²⁺ and Al³⁺, respectively. In some embodiments, the molar ratio of Mg²⁺ to Al³⁺ is 1:1, 1.5:1, 2:1, 3:1, or 4:1. In one embodiment, the ratio of Mg²⁺ to Al³⁺ is from 1:1 to 1.5:1, from 1.5:1 to 1.8:1, from 1.8:1 to 2.2:1, or from 1.9:1 to 2.1:1. Other ratios are acceptable where the value in the ratio for the magnesium cation can vary from the aforementioned values by ±0.5, including ±0.4, ±0.3, ±0.2, ±0.1, ±0.05, ±0.02, and ±0.01.

In some embodiments, the LDO is provided in a particulate form, such as a powder or granules of LDO. In accordance with some embodiments the LDO particles can have a primary particle size from 50 nm to 500 nm when measured using transmission electron microscopy (TEM). In various embodiments, the primary particle size can be <50 nm, <100 nm, <200 nm, <300 nm, <400 nm, <500 nm, or <1 μm. The particles may be similarly sized and the particle size distribution can have a standard deviation of less than 100 nm, less than 50 nm, less than 20 nm, less than 10 nm or less than 5 nm. Often these primary particles may be present in the form of larger aggregates or agglomerates. In some cases, the agglomerates are broken up into smaller particles or even into primary particles. In various cases, after grinding, the LDO, LDH or LDO/LDH median agglomerate size D₅₀ is from 1 μm to 20 μm, from 2 μm to 10 μm, from 2 μm to 5 μm, from 1 μm to 10 μm, from 0.5 μm to 10 μm, from 1 μm to 5 μm, from 0.5 μm to 5 μm, from 1 μm to 2 μm, from 0.5 μm to 1 μm, from 0.1 μm to 0.5 μm, from 0.1 μm to 1 μm, or from 0.1 μm to 2 μm. In these and other embodiments, the agglomerates can have a D90 of less than 50 μm, less than 30 μm or less than 10 μm. Calcining typically does not substantially change the amount or size of agglomerates. Some breaking up of the agglomerates can occur when the particles are dispersed into the prepolymer.

In addition to particle size, LDOs can be selected to have desired geometry, surface area, or other characteristics. For instance, in some embodiments, the LDOs have a rosette shape, a platelet shape, an elongated shape, a cubic shape, a spherical shape, or some other geometry. Moreover, the shape of an LDO particle can remain the same as that of the starting LDH from which the LDO is produced. Similarly, once an LDO transitions to an LDH, the shape of the LDH can remain the same as that of the starting LDO. In some embodiments, a mixture of LDOs is used, where the composition includes different chemical structures, contains a plurality of particle size distributions and/or a plurality of particle shapes.

The LDO particles can have an average BET surface area of at least 100 m²/g in accordance with an embodiment of the present disclosure. In some embodiments, the BET surface area is at least 125 m²/g, at least 150 m²/g, at least 175 m²/g, at least 200 m²/g, at least 225 m²/g, or at least 250 m²/g. LDO particles have a structure that can be measured in terms of oil absorption number (OAN) using ASTM D281 (1995). OAN is indicative of the ability of an LDO to adsorb liquids and, in particular, the composition's compatibility with non-polar media. In example compositions, the LDO particles are agglomerates with an OAN of at least 100 cm³/100 g, at least 150 cm³/100 g, at least 175 cm³/100 g, or at least 200 cm³/100 g. A higher OAN indicates greater compatibility of LDO particles with non-polar media.

The polyurethane adhesive, curable resin, and other compositions disclosed herein optionally can include additional components in accordance with various embodiments. In one set of examples, in addition to LDO/LDH, the adhesive or resin contains a carbonaceous material such as carbon black in an amount from 1% to 30% by weight. The ratio of LDO particles to carbon black particles, by weight, can be, for example, greater than 0.5:1, greater than 1:1, greater than 2:1, greater than 5:1 or greater than 10:1. In the same and other embodiments, the ratio can be less than 50:1, less than 10:1, less than 5:1, less than 2:1, less than 1:1 or less than 0.5:1. Carbon black can be included to provide a black color to the composition, can be included as a reinforcing filler, and/or can contribute to removal of carbon dioxide in the cured polyurethane. Other optional components can include one or more stabilizers, plasticizers, hydrophilic material, reinforcing fillers, pigments, clays and other additives as needed to provide the desired appearance or physical properties of the composition.

The plasticizer may include phthalate plasticizers (e.g. di(2-propylheptyl) phthalate, dioctyl phthalate, diisononyl phthalate, diisodecyl phthalate, diisoundecyl phthalate, diisotridecyl phthalate, or mixed phthalates), adipic ester plasticizers (e.g. dioctyl adipate), sebacic ester plasticizers (e.g. dioctyl sebacate), fatty acid ester plasticizers, and phosphate plasticizers (e.g. tricresyl phosphate, epoxidized soya oils, linseed oils, benzoic esters or sulphonic esters). These plasticizers can be added to the polyurethane prepolymer or to the polyurethane adhesive.

The fillers may include inorganic filler materials. Specific fillers include carbon black, calcium carbonate, fumed silica, clay e.g. calcined kaolin clay. Different fillers can be used for different purposes. For example, carbon back can be used as a filler to provide UV resistance characteristics. Alternatively, at least one of carbon black, calcium carbonate and clay can be used as a filler to provide reinforcement to the adhesive.

In some embodiments, the moisture-cured polyurethane adhesive is selected to have a desired appearance. For example, the polyurethane adhesive can be at least somewhat transparent to visible light (light having a wavelength from 400 nm to 700 nm). In some embodiments, the polyurethane adhesive has a light transmittance value of at least 1%, at least 10%, at least 20%, at least 50%, or at least 85% of incident light in the visible spectrum. In some embodiments, the transmittance value may be measured with respect to specific wavelengths or with respect to a range of wavelengths within the visible spectrum. Haze and transmission can be measured using method of ASTM E179 (“Standard Guide for Selection of Geometric Conditions for Measurement of Reflection and Transmission Properties of Materials”) and ASTM D1003 (“Standard Test Method for Haze and Luminous Transmittance of Transparent Plastics”). Other measurement methods are acceptable in accordance with some embodiments. Transmittance and other optical properties of the cured polyurethane adhesive can be affected, for example, by the content of carbonaceous material and other components in accordance with embodiments of the present disclosure.

In example compositions containing carbon black, the BET surface area of the carbon black is at least 50 m²/g, at least 100 m²/g, at least 150 m²/g, or at least 200 m²/g. The OAN of carbon black can be, for example, at least 75 cm³/100 g, at least 100 cm³/100 g, or at least 150 cm³/100 g.

In some embodiments, the cured polyurethane has an electrical conductivity not greater than 2E-11 S/cm (i.e., resistivity of at least 5E10 Ω-cm). In other embodiments, the electrical conductivity is not greater than 5E-10, not greater than 2E-10 S/cm or not greater than 1E-10 S/cm. In other embodiments, the electrical conductivity is not greater than 3.5E-9, not greater than 2E-9, not greater than IE-9, or not greater than 7E-10 S/cm. Methods to control the electrical conductivity of the polymer composite adhesive include limiting the amount of LDO beyond the sufficient stoichiometric amount and limiting the amount of or excluding conductive fillers, such as carbon black (CB). In some embodiments, LDO/LDHs block electron transfer between carbon black particles, thereby reducing the effective electrical conductivity. Thus, in some embodiments that include carbon black, LDOs are added in excess to the amount required to consume generated CO₂ in order to reduce the conductivity introduced by carbon black fillers. In other embodiments, LDH particles can be added to the composite polymer to reduce the electrical conductivity that is promoted by carbon black or other carbonaceous materials. These prepolymer embodiments can include LDO/LDH/CB, LDO/CB or LDH/CB. After cross-linking, the result can be a composite polymer having lower electrical conductivity than a comparable polymer containing the same amount of carbon black or other conductive filler. In some embodiments, an LDH content of 2.5% or greater has been shown to reduce the conductivity in polyurethane compositions having carbon black loadings up to 30% by weight to less than 2E-11 S/cm. Further, for polyurethane compositions containing carbon black, the addition of LDO in an amount of 0.5% or greater can significantly improve the removal of CO₂ and reduce conductivity. Thus, in accordance with some embodiments, polyurethane compositions can have a carbon black content from 1 to 30% and an LDH/LDO content of 0.5 to 40% by weight, including any sub ranges such as discussed above. When compared to the conductivity of the same compositions absent the LDH/LDO component, in some embodiments, these compositions can reduce the conductivity by more than 10%, 20% or 30%.

In some embodiments, the cured polyurethane contains less than 5% gaseous CO₂ on a volume basis. In some embodiments, the cured polyurethane is substantially free of CO₂ or substantially free of gaseous CO₂. As used herein, “substantially free” means containing less than 1.0% of the element or compound on a wt/wt basis. In other embodiments, the cured polyurethane is essentially free of gaseous CO₂ or total CO₂. As used herein, “essentially free” means containing less than 0.1% of the element or compound on a wt/wt basis. In yet other embodiments, the cured polyurethane contains no detectable CO₂ or no detectable gaseous CO₂.

In various embodiments, the LDO can be delivered to the prepolymer as a powder or in a masterbatch. The masterbatch can be any material that can be incorporated in the polyurethane. For example, the masterbatch can comprise a polyurethane prepolymer, an isocyanate or a polyol. The masterbatch can include a loading of LDO particles at a high concentration, such as greater than 20%, greater than 30%, greater than 40% or greater than 50%. The use of a masterbatch allows an adhesives formulator to produce the composition without requiring the addition of a dry powder to the formulation. Dry powders can be difficult to incorporate into polymer compositions and can result in airborne particles that can be a safety hazard. Powders can also become clumped and can be difficult to disperse evenly throughout a prepolymer. If the LDO is well dispersed in the masterbatch, it can be quickly incorporated into the prepolymer mixture by mixing the masterbatch with the other components of the adhesive. The masterbatch resin may also serve to protect the LDO from exposure to the atmosphere. The masterbatch can include additional additives such as carbon black, pigments, fillers, plasticizers and antioxidants.

Method of Making

Referring to FIG. 1, a flowchart illustrates a method 100 of making a polyurethane in accordance with embodiments of the present disclosure. Method 100 includes combining 110 an isocyanate component and a polyol component to form a prepolymer composition.

Consistent with polyurethane chemistry, the isocyanate component is added in an excess amount to the polyol component. In one example, the isocyanate component is a diisocyanate such as toluene diisocyanate (TDI) or polymeric isocyanate (PMDI). Other isocyanate components are acceptable, including MDI, 1,5-napthalene diisocyanate and bitolylene diisocyanate, and others.

A polyol is understood as meaning a polyol with more than one OH group, preferably two terminal OH groups. Polyester polyols are usually preferred. Suitable polyol components can be prepared in known manner, e.g. from aliphatic hydroxycarboxylic acids or aliphatic and/or aromatic dicarboxylic acids and one or more diols. It is also possible to use appropriate derivatives, e.g. lactones, esters of lower alcohols, or anhydrides. Examples of starting materials are succinic acid, adipic acid, suberic acid, azelaic acid, sebacic acid, dodecanedioic acid, glutaric acid, glutaric anhydride, phthalic acid, isophthalic acid, terephthalic acid, phthalic anhydride, ethylene glycol, diethylene glycol, 1,4-butanediol, 1.6-hexanediol, neopentylglycol and caprolactone.

Examples of suitable crystallizing polyesters are those based on linear aliphatic dicarboxylic acids having at least 2 carbon atoms, e.g. adipic acid, azelaic acid, sebacic acid and dodecanedioic acid, preferably adipic acid and dodecanedioic acid, and on linear diols having at least 2 carbon atoms, e.g. 1,4-butanediol and 1,6-hexanediol. Polycaprolactone derivatives based on bifunctional starter molecules, e.g. 1,6-hexanediol, may also be mentioned as particularly suitable.

Examples of suitable amorphous polyester polyols are those based on adipic acid, isophthalic acid, terephthalic dimethylpropyl-3-hydroxy-2,2-dimethylpropanoate. Examples of suitable polyester polyols that are liquid at room temperature are those based on adipic acid, ethylene glycol, 1.6-hexanediol and neopentylglycol.

Suitable polyether polyols are the polyethers conventionally used in polyurethane chemistry, e.g. the addition or mixed addition compounds of tetrahydrofuran, styrene oxide, ethylene oxide, propylene oxide, butylene oxides or epichlorohydrin, preferably of ethylene oxide and/or propylene oxide, prepared using dihydric to hexahydric starter molecules, e.g. water, ethylene glycol, 1.2- or 1,3-propylene glycol neopentyl glycol, glycerol, trimethylolpropane, pentaerythritol or sorbitol, or amines having 1 to 4 NH bonds. The bifunctional propylene oxide and/or ethylene oxide adducts, and polytetrahydrofuran may also be used.

A quantity of layered double oxide (LDO) powder is added 115 in an amount from 0.5% to 40% by weight of the composition, or other amount in this range as discussed above. In two specific embodiments, the LDO is present at 10% or 20% by weight. The LDO can be mixed into the composition and dispersed, for example, using a high-speed centrifugal mixer.

Layered double oxides (LDO) can be produced by calcining 135 layered double hydroxides (LDH). The LDHs can be produced by grinding 140 layered double hydroxide (LDH) materials that can be either synthetic or naturally occurring. In some embodiments, the LDO is provided as the calcined form of a layered double hydroxide (LDH). For example, the LDH can be calcined at a temperature from 300° C. to 600° C. for five hours to initiate a phase transformation and convert the LDH to its oxide form. In one set of embodiments, the LDH comprises hydrotalcite, LiMgAl—C03, or Mg₂Al-stearate comprising magnesium and aluminum in ratios as discussed above.

In some embodiments, the LDH is subjected to an aqueous miscible organic solvent treatment (AMOST) process to increase, for example, its OAN. In one embodiment, the AMOST process includes wetting the LDH with water, followed by contacting the wet LDH with a solvent miscible with water. For example, the solvent can have a polarity index (P′) value from 3.8 to 9, where polarity P′ is defined by Snyder and Kirkland (Snyder, L. R., Kirkland, J. J., Introduction to Modern Liquid Chromatography, 2^{nd} ed., pp. 248-250 (John Wiley & Sons 1979). Optionally, the process includes heat treating or calcining the LDH at a temperature up to 950° C. The result of this process is a highly porous, highly dispersed LDH. In one embodiment, the LDH wet with water is dispersed in acetone, followed by rinsing in acetone to remove surface-adsorbed water molecules, and then drying at 65° C. to provide an LDH powder that can subsequently be calcined. Other acceptable solvents include ethanol, methanol, acetonitrile, dimethylformamide, dimethyl sulfoxide, dioxane, n-propanol, isopropanol, and tetrahydrofuran. Additional embodiments of the AMOST process are described, for example, in WO2014/051530, which is incorporated herein by reference in its entirety.

The AMOST process can increase the OAN of LDHs from about 80-100 cm³/100 g to about 180-200 cm³/100 g. In embodiments, the average primary particle size of the LDH/LDO can be, for example, from 50 nm to 500 nm, or can be other particle sizes as provided above. In some other embodiments, the average primary particle size of the LDO (or LDH) can be, for example, from 50 nm to 1 μm. In other embodiments, the LDH/LDO has a median aggregate particle size D₅₀ from 2 μm to 10 μm. In some cases, the size distribution of the particles may be narrow. For example, the D₁₀ and D90 of the particles can be, independently, within 5%, 10%, 20%, 30%, 40%, 50%, 75%, 100% or 200% of the D50 value. In other embodiments, the pre-calcined LDH is provided as a bulk solid that can be ground 140 into a powder or granular form before calcining to LDO. The ground LDH may be screened to provide a suitable or desired aggregate particle size distribution. Grinding 140 the LDH into a powder or granular form is an optional process that is performed prior to calcining when the LDH is not in a suitable powder or granular form.

In some embodiments, calcining 135 the LDH also includes a step of cooling 145 the calcined LDO to a desired temperature. In some embodiments, the LDO is cooled to 200° C. or below, such as 150° C. or below, or 100° C. or below. In some embodiments, cooling 145 occurs in an oxidizing environment, in an inert environment, or in vacuum. After cooling to the desired temperature, the LDO can be collected in an air-tight container, such as a glass bottle or sealed vial.

Optionally, additional fillers or additives are added 125 to the polymer composition. For example, in some embodiments carbon black is added in an amount from 1% to 30% by weight of the composition. Other optional components include one or more stabilizers, plasticizers, hydrophilic material, reinforcing fillers, clays and/or other additives. The additional fillers or additives can be added before or after combining 110 the isocyanate component and the polyol component. The additional fillers may also be added together with the LDO or at a separate time.

To cure 130 the polymer, the composition is exposed to moisture to form a crosslinked polyurethane adhesive. The addition of LDOs removes, sequesters or adsorbs carbon dioxide generated during the curing 130 process. Absent the LDOs, the carbon dioxide would gas off and result in bubbles or voids in the cured polyurethane. However, by adding LDOs to the prepolymer, the carbon dioxide is consumed to provide a low-void or no-void cured polyurethane adhesive.

Experimental Results

Materials used in experiments include a polyurethane prepolymer sold as Desmoseal M280 by Covestro. Desmoseal M280 contains about 2% free isocyanate (NCO—). Desmoseal M280 is provided as a solvent-free aromatic prepolymer in liquid form based on diphenylmethane diisocyanate. Desmoseal M280 can be used as a binder for moisture-curing one-component polyurethane sealants. Layered double hydroxides (LDHs) were calcined in a muffle furnace at 400° C. for five hours to obtain the oxide form as LDOs. The LDOs were then allowed to cool to below 100° C. prior to collecting and sealing the LDOs in glass bottles to avoid moisture and air exposure. Different LDOs were mixed into the Desmoseal M280 at the loadings provided in Table 1. Various curable polyurethane compositions were prepared containing LDOs, where the LDOs have a Mg:Al molar ratio of 2:1, 3:1, and 4:1. Additional prepared compositions contained LDOs with a Zn:Mg: A1 ratio of 2:1:1. LDO loadings of 10% and 20% were evaluated. The effect of AMOST treatment on the LDOs was also evaluated. A summary of the compositions and related figure is contained in Table 1 below:

TABLE 1

| Sample | Metal Ions | AMOST | LDO | BET | OAN |
|---|---|---|---|---|---|
| No. | and Ratio | treatment | loading | (m²/g) | (cm³/100 g) |
| 2A | Mg, Al | Yes | 10% | 185 | 195 |
| | 3:1 | | | | |
| 2B | Mg, Al | Yes | 10% | 240 | 190 |
| | 3:1 | | | | |
| 2C | Mg, Al | No | 10% | 180 | 85 |
| | 3:1 | | | | |
| 2D | Zn, Mg, Al | Yes | 10% | 125 | 185 |
| | 2:1:1 | | | | |
| 2E | Zn, Mg, Al | No | 10% | 120 | 125 |
| | 2:1:1 | | | | |
| 2F | Mg, Al | Yes | 20% | 185 | 195 |
| | 3:1 | | | | |
| 2G | Mg, Al | Yes | 20% | 240 | 190 |
| | 3:1 | | | | |
| 2H | Mg, Al | No | 20% | 180 | 85 |
| | 3:1 | | | | |
| 2I | Zn, Mg, Al | Yes | 20% | 125 | 185 |
| | 2:1:1 | | | | |
| 2J | Zn, Mg, Al | No | 20% | 120 | 125 |
| | 2:1:1 | | | | |
| 3A | Mg, Al | No | 10% | 220 | 100 |
| | 2:1 | | | | |
| 3B | Mg, Al | No | 10% | 225 | 85 |
| | 3:1 | | | | |
| 3C | Mg, Al | No | 10% | 215 | 80 |
| | 4:1 | | | | |
| 3D | Mg, Al | No | 20% | 220 | 100 |
| | 2:1 | | | | |
| 3E | Mg, Al | No | 20% | 225 | 85 |
| | 3:1 | | | | |
| 3F | Mg, Al | No | 20% | 215 | 80 |
| | 4:1 | | | | |

Adhesive formulations were prepared from a mixture of components that include the Desmoseal prepolymer and layered double oxides (LDOs). LDOs were added to the polyurethane prepolymer in an amount of 10% or 20% by weight. The components were mixed using a high-speed centrifugal mixing machine to obtain a homogeneous dispersion without trapped air bubbles. The mixture was then cast to a cured specimen with a three-inch diameter and 2 mm thickness for appearance observation and further testing to determine properties of the cured adhesives. The cast samples are shown in FIGS. 2A-2J and 3A-3F.

The amount of gaseous CO₂ in the cured adhesives was evaluated by observing the appearance of the cured adhesives with the naked eye and with an optical microscope. Specifically, the cured polyurethane was evaluated visually to determine the quantity and size of bubbles or voids. Electrical conductivity of the cured adhesives was determined by calculation from the volume resistance of each sample, where 500 V potential was applied across the specimen for one minute.

The void content of each sample of polyurethane adhesive was observed visually and compared to the appearance of other samples made with LDOs and a control sample made without LDOs. As shown in FIG. 4, for example, samples prepared without LDOs contained many voids and larger voids due to the release of CO₂ upon curing in a reaction with the polyurethane prepolymer. Specifically, the curing reaction between the free isocyanate group (NCO—) of the prepolymer and moisture in the air resulted in the release of CO₂. Accordingly, the amount of free NCO— in the prepolymer likely influenced the number and volume of voids.

Experimental data indicate that several parameters affect the carbon dioxide capture performance of LDOs as shown by the different amounts of voids or bubbles in the finished samples. FIGS. 2A-2J show cured polyurethane samples from compositions containing 10% or 20% LDO content by weight. The samples in FIGS. 2A-2E (left column) contain 10% LDOs; the samples in FIGS. 2F-2J (right column) contain 20% LDOs. The samples of FIGS. 2A-2E exhibit increased voids compared with samples 2F-2J, respectively, having the same composition except for a 20% LDO loading. Thus, 20% LDO loading provided improved performance over 10% LDO loading.

In addition to changing the loading of LDO between 10% or 20%, differences in the primary particle size, surface area, OAN values, and metal element composition were tested. Experiments showed that the specific metal composition of the LDO had the greatest influence on the carbon dioxide capture performance. Samples prepared from formulations using different LDOs with different metals and morphologies were tested. In the samples shown in FIGS. 2D, 2E, 2I, and 2J, (bottom two rows) zinc partially replaced magnesium. The cured samples of FIGS. 2A-2C and 2F-2H contain magnesium and aluminum in a ratio of 3:1 (no zinc). The cured samples of FIGS. 2D-2E and 2I and 2J contain LDOs with zinc, magnesium, and aluminum at a ratio of 2:1:1. The results of the experimental data indicate better performance (i.e., fewer voids) with LDOs composed of Mg and A1 compared to LDOs with Zn, Mg, and Al.

Experiments show that increasing the OAN value of the LDOs by, for example, an AMO treatment process improved the performance of carbon dioxide capture. LDOs with both Zn—Mg—Al and Mg—Al formulations were subjected to AMO treatment and evaluated by compounding the LDOs into urethane adhesives and evaluating the cured adhesives for voids. Samples of FIGS. 2A, 2B, 2D, 2F, 2G, and 2I were prepared with LDOs subjected to AMO treatment. The LDOs subjected to AMO treatment have an OAN value of about 180-200 cm³/100 g versus about 80-100 cm³/100 g for LDOs not subjected to AMO treatment. The performance of carbon dioxide capture of the samples containing LDOs subjected to AMO treatment is improved over samples containing LDOs not subjected to AMO treatment. The difference can be observed by visual comparison of the samples of FIGS. 2B vs. 2C, 2D vs. 2E, 2G vs. 2H, 2I vs. 2J, where the first listed sample in each pair contains LDOs of higher structure. In most cases, samples containing LDOs with higher OAN (structure) values (FIGS. 2B, 2D, 2G, 2I) exhibit a smoother appearance with fewer voids and/or smaller voids than the same composition in which the lower structure, untreated LDO was used (FIGS. 2C, 2E, 2H, and 2J, respectively).

Among samples 2A-2J, the sample of FIG. 2F exhibits the fewest voids. This sample was prepared with a LDO loading of 20%, where the LDO contains Mg and Al in a ratio of 3:1, has a BET of 190 m²/g and to achieve an OAN of about 195 cm³/100 g. The cured sample of FIG. 2F exhibits an electrical conductivity of about 2E-10 S/cm.

Further experiments were performed to determine the effect on CO₂ capture performance based on the ratio of magnesium to aluminum as determined by the number of voids observed in the cured product. With continued reference to Table 1 above, six formulations are shown in FIGS. 3A-3F with LDO loading of either 10% or 20% by weight and a Mg: Al ratio of 2:1, 3:1, or 4:1. FIGS. 3A-3F show cured polyurethane samples prepared with LDOs having an Mg:Al ratio with values of 2:1 (FIGS. 3A & 3D), 3:1 (FIGS. 3B & 3E), or 4:1 (FIGS. 3C & 3F), where the LDOs had similar values for BET surface area and OAN. Samples of FIGS. 3A-3C have an LDO loading of 10%; samples of FIGS. 3D-3F have an LDO loading of 20%.

Among samples 3A-3F, the sample of FIG. 3D exhibits the fewest voids. This sample was prepared with a LDO loading of 20%, where the LDO contains Mg and Al in a ratio of 2:1. None of the samples shown in FIGS. 3A-3F contained LDOs subjected to AMO treatment. The cured polymer was prepared with LDOs having an OAN of about 100 cm³/100 g and a BET surface area of about 220 m²/g. The cured sample exhibits an electrical conductivity of about 3.59E-11 S/cm. Based on having the fewest voids, the results of this experiment indicate that a 20% loading of LDO with Mg: A1 ratio of 2:1 provided the best performance of the three tested ratios.

Experimental data for compositions of FIGS. 2A-2J indicates that the addition of LDOs to the prepolymer has only marginal impact on the rheological properties of the cured polymer, including little or no change in shear thinning behavior. Viscosity of the prepolymer compositions increased after adding LDOs in an amount up to 10% by weight, but not significantly to where performance of the polymer was affected. These data indicate that LDOs can be added to commercially available prepolymer compositions without significantly affecting performance of the cured polymer.

For comparison purposes, FIG. 4 shows a cured polyurethane sample as prepared using conventional methods without LDOs. The sample of FIG. 4 exhibits a greater number of voids and exhibits voids of a greater size compared to samples of FIGS. 2A-2J and 3A-3F prepared according to embodiments of the present disclosure. Accordingly, experiments show that the use of LDOs in polyurethane prepolymer compositions results in a cured polyurethane or polyurethane adhesive with reduced voids compared to conventional methods.

Further experiments were conducted to determine the effect of incorporation of an LDO in a polyurethane on the crystallinity of the LDO. The crystal structures of an LDO, an LDH, a cured polyurethane and the LDO incorporated cured polyurethane samples were determined by X-ray diffraction (X-ray diffractometer, PANalytical, X'Pert PRO) using Cu Kα radiation operated at 40 kV, 30 mA, step angle of 0.02°, count time of 0.5 sec, and D-, R- and S-slits of 1°, ½° and ¼° respectively.

FIG. 5 provides XRD spectra of an LDO, an LDH, a cured polyurethane, and a LDO incorporated cured polyurethane, illustrating the phase change of the LDO upon its incorporation in the polyurethane prepolymer and subsequent curing with moisture to produce a polyurethane. The LDO was produced by calcining an LDH, Mg3AlCO3. As described earlier, XRD generates separate characteristic peaks for LDH and LDO. For instance, an LDH exhibits intense peaks (003) at about 12° (2θ) and (006) at about 23° in addition to smaller peaks (012) at about 34°, (015) at about 39°, (018) at about 47°, (110) at about 61° and (111) at about 63° as can be seen in FIG. 5. An LDO lacks intense peaks and exhibits less intense and broad peaks (200) at about 44° and (220) at about 63° as evident in FIG. 5. These broad and less intense peaks indicate a less ordered crystalline structure. The reduction in LDH's peak intensity, in general, is proportional to the extent of the LDH conversion to the LDO. The relative intensities of the LDH and LDO peaks indicate the relative amounts of the LDH and LDO in a material and the extent of the phase transformation from LDH to LDO upon calcination. Polyurethane prepolymers are non-crystalline and generally do not show a sharp peak in their XRD pattern as evident in FIG. 5. However, when LDO, which is produced by calcining LDH at 400° C., is mixed to a polyurethane prepolymer at 20% loading, the mixture of polyurethane and LDO exhibits characteristic peaks of LDH in the XRD spectra of the mixture as shown in FIG. 5. The LDH characteristic peaks in the polyurethane and LDO mixture, albeit less intense, indicate that a portion of the initial LDOs has converted to LDHs. Upon mixing LDOs into a polyurethane prepolymer and subsequently curing the mixture, LDOs adsorb CO₂ and convert either partially or fully to LDHs.

Furthermore, four experiments were conducted to measure the CO₂ capture capacities of different LDOs produced from different LDHs. LDHs used in these experiments were different in terms of their chemical formula and/or their exposure to calcination temperatures. FIG. 6 shows the CO₂ capture capacities of three LDOs produced from three LDHs with different chemical formulae. FIG. 7 shows the CO₂ capture capacity of three LDOs produced by calcining a single LDH at three different temperatures. FIG. 8 shows the CO₂ capture capacity of LDOs produced from four LDHs having four different lithium ions loadings. FIG. 9 shows the CO₂ capture capacities of an LDO and two commercially available carbon blacks.

FIG. 6 demonstrates CO₂ capture capacities of three LDOs produced from three LDHs having three different chemical formulae in a test conducted using a thermal analyzer. In one experiment, three LDO produced from three LDHs having chemical formula —Mg2Al.CO₃ (labelled as MC21P), Mg₃Al.CO₃ (labelled as MC31P), and Mg₄Al.CO₃ (labelled as MC41P)—were subjected to analysis by a thermal analyzer (NETZSCH TG 209F1 Libra) under a CO₂ gas flow rate 20 ml/min. The LDHs were analyzed under these conditions for up to 140 minutes. The CO₂ capture capacities of LDOs (obtained by calcining LDHs at 400° C. for 5 hours) were measured in terms of mmol/g, i.e. millimoles of CO₂ captured by one gram of an LDO over a period of time during analysis.

It is evident from FIG. 6 that LDO produced by calcining Mg₄Al.CO₃ (labelled as MC41P) exhibits the highest CO₂ capture capacity followed by the LDO produced by calcining Mg₃Al.CO₃ (labelled as MC31P). LDO produced by calcining Mg2Al.CO₃ (labelled as MC21P) exhibits the lowest CO₂ capture capacity among the three LDOs. The result thus indicates that the number of Mg²⁺ in LDHs from which the LDOs are produced significantly contributes to the CO₂ capture capacities of LDHs.

FIG. 7 demonstrates CO₂ capture capacities of three LDOs produced by calcining a single LDH at three different temperatures in a test conducted using a thermal analyzer. In one experiment, Mg2Al.CO₃ calcined at 550° C. (labelled as MC21-550), at 750° C. (labelled as MC21-750), and at 880° C. (labelled as MC21-880)—were subjected to a thermal analyzer (NETZSCH TG 209F1 Libra) under a CO₂ gas flow rate of 20 ml/min. The CO₂ capture capacities of LDOs produced by calcining an LDH at three different temperatures were measured in terms of mmol/g, i.e. millimoles of CO₂ captured per gram of an LDH over a period 140 minutes.

As can be seen in FIG. 7 that the Mg2Al.CO₃ calcined at 880° C., (labelled as MC21-880), exhibits the highest CO₂ capture capacity followed by the Mg2Al.CO₃ calcined at 750° C. (labelled as MC21-750). The Mg2Al.CO₃ calcined at 550° C. (labelled as MC21-550) exhibits the lowest CO₂ capture capacity among the three LDOs. The result thus indicates that the calcination temperature contributes significantly to the CO₂ capture capacity of LDOs, i.e. calcined LDHs.

In another experiment, an LDH samples were calcined at three different temperatures—at 550° C. (labelled as MC21-550), at 750° C. (labelled as MC21-750), and at 880° C. (labelled as MC21-880), and their surface areas and pore volumes post-calcination were measured using Quadrasorb evo gas sorption surface area and pore size analyzer. The measurement involved a 9 mm large bulb sample cell, a degassing condition of 300° C. for 3 hours, and nitrogen gas. MC21 is Mg2AlCO₃. The surface areas and pore volumes were analyzed for their effect on the CO₂ capture capacities of Mg2Al.CO₃ calcined at 550° C. (labelled as MC21-550), at 750° C. (labelled as MC21-750), and at 880° C. (labelled as MC21-880).

The surface areas and pore volumes are provided in Table 2 below.

TABLE 2

| | Calcining Temperature | Surface Area | Pore Volume |
|---|---|---|---|
| Sample Code | (° C.) | (m²/g) | (cc/g) |
| MC21-550 | 550 | 124.6 | 0.6616 |
| MC21-750 | 750 | 119.9 | 0.6651 |
| MC21-880 | 880 | 116.6 | 0.7134 |

As can be seen in FIG. 7, the CO₂ capture capacity of MC21-880 is the highest among the LDHs calcined at three temperatures. The CO₂ capture capacity of MC21-880 is proportional to the largest pore volume of MC21-880 as shown in Table 2. Although, the surface area of a calcined LDH influences its CO₂ capture capacity, the pore volume of the calcined LDH is more directly linked to the CO₂ capture capacity of that calcined LDH. These data indicate that the CO₂ capture capacity of a calcined LDH is directly proportional to the pore volume of the calcined LDH.

In another experiment, an LDH, for instance Mg₂Al.CO₃, was loaded with lithium at four different doses—0% lithium loading (labelled as Mg₂Al-CO₃_02), 25% lithium loading (labelled as ExpAll_MgAl-25Li-CO₃-2), 50% lithium loading (labelled as ExpAll_MgAl-50Li-CO₃-2), and 75% lithium loading (labelled as ExpAll_MgAl-75Li-CO₃-2). Lithium was incorporated during preparation of LDH by co-precipitating LiNO₃ along with Mg(NO₃)₂. All these LDH were calcined to produce their corresponding LDOs which were used to determine their CO₂ capture capacities.

As can be seen from FIG. 8, the CO₂ capture capacity of an LDO increases with the increase in amount of lithium in the corresponding LDH from which the LDO was produced.

Therefore, it is evident that lithium improves the CO₂ capture capacity of an LDO.

In yet another experiment, the CO₂ capture capacity of an LDO, labelled as MC21P-200, was directly compared with two commercially available carbon blacks—Printex 3 and Nerox 600. MC21P-200 is an LDO which was produced from Mg₂Al.CO₃ having a platelet structure and possesses a BET of 200 m²/g.

As can be seen in FIG. 9, the CO₂ capture capacity of a MC21P-200 is more than the double of the CO₂ capture capacities of Printex 3 and Nerox 600. This indicates that the MC21P-200 is a better candidate for use in a polyurethane manufacturing process.

In another experiment, the mechanical properties of cured polyurethane adhesives loaded with different quantities of LDOs was evaluated. By varying the amount of carbon black (Printex 3) and LDO (which was calcined Mg₂AlO) in a PU prepolymer, following four formulations were prepared—1) 80% PU prepolymer, 0% LDO and 20% carbon black (labelled as CB20); 2) 80% PU prepolymer, 2.5% LDO and 17.5% carbon black (labelled as CB17.5+LD02.5); 3) 80% PU prepolymer, 5% LDO and 15% carbon black (labelled as CB15+LD05); and 4) 80% PU prepolymer, 7.5% LDO and 12.5% carbon black (labelled as CB12.5+LD07.5). To determine the tensile strength and strain, the formulations were mixed with a high-speed centrifugal mixer followed by casting them into 2 mm thick sheets. After curing the sheets for 7 days, the cured polyurethane adhesive sheets were then die-punched to a dumbbell shaped specimen for tensile strength and strain measurements. The measurements were done using an Instron 3366 according to ISO 37 with crosshead speed at 250 mm/min. The constituents of different cured polyurethane adhesives and their respective tensile strengths and strains are provided in Table 3 below.

TABLE 3

| | | CB17.5 + | CB15 + | CB12.5 + |
|---|---|---|---|---|
| Formulation | CB20 | LDO2.5 | LDO5 | LDO7.5 |
| Prepolymer | 80% | 80% | 80% | 80% |
| (Covestro | | | | |
| M280) | | | | |
| LDO | 0% | 2.5% | 5% | 7.5% |
| Printex 3 | 20% | 17.5% | 15% | 12.5% |
| Tensile | | | | |
| properties | | | | |
| Tensile | 3.62 | 3.49 | 4.10 | 4.18 |
| strength | | | | |
| (MPa) | | | | |
| Strain (%) | 135 | 124 | 153 | 157 |

As can be seen in FIG. 10, with the incorporation of LDO in the PU prepolymer, the mechanical property of the polyurethane has improved. The cured polyurethane adhesives with the highest amount of LDO exhibits the maximum mechanical strength as measured in terms of tensile strength and tensile strain.

Further experiments were conducted to determine the effect of LDO loading on the rheological properties of a polyurethane prepolymer. Two polyurethane formulations-polyurethane prepolymer loaded with 10% carbon black and 5% LDO by weight (labelled as Printex.MC21-10.5), and polyurethane prepolymer loaded with 10% carbon black (labelled as Printex-10)—were prepared, and their rheological behavior were evaluated using a rheometer at different shear rate. Carbon black used was in the form of Printex 3. The LDO was produced by calcining Mg₂AlO, and is labelled as MC21. Desmoseal M280 was used as polyurethane prepolymer. The presence of LDO in the polyurethane formulation exhibited a shear thinning behavior as shown by the hysteresis rheology curves in FIG. 11.

Furthermore, the test samples were also subjected to a sag resistance test. A metal applicator bar along with a drawdown card was used for the sag resistance test. The test samples were poured into a circular mold of 20 mm diameter and 4 mm thickness. As can be seen in FIG. 12, the presence of LDO (labelled as MC21) in the polyurethane adhesive significantly improved the non-sagging property of the adhesive. The sag resistance properties of the adhesive with 5% LDO loading is significantly better than that of the adhesive with no LDO loading. For example, after one hour, the sag distance is less than one half the drop of the polyurethane/carbon black without the LDO.

The foregoing description of example embodiments of the invention has been presented for the purposes of illustration and description. It is not intended to be exhaustive or to limit the invention to the precise forms disclosed. Many modifications and variations are possible in light of this disclosure. It is intended that the scope of the invention be limited not by this detailed description, but rather by the claims appended hereto.

1-133. (canceled)

134. A moisture-curable polyurethane prepolymer comprising 0.5% to 40% by weight of layered double oxide particles dispersed in the prepolymer.

135. The moisture-curable polyurethane prepolymer of claim 134, wherein the prepolymer is a reactive polyurethane hot-melt.

136. A moisture-cured polyurethane produced from the prepolymer of claim 134, wherein the polyurethane is substantially free of CO₂.

137. The moisture-cured polyurethane of any of claim 136, wherein the polyurethane has a thermal conductivity of less than 1.5 W/(m·K).

138. The moisture-cured polyurethane of claim 136, wherein the layered double oxide particles exhibit at least partial phase change to layered double hydroxide particles during moisture curing.

139. The moisture-cured polyurethane of claim 136, wherein the polyurethane has at least one value selected from (i) a tensile strength according to ASTM D412 of from 3 MPa to 5 MPa, (ii) an elastic modulus of at least 1 MPa at 25° C., (iii) an electrical conductivity not greater than 5E-10 S/cm, (iv) an optical transmittance value of at least 1% for light having a wavelength from 400 nm to 700 nm, and (v) having no voids with a diameter greater than 0.2 mm.

140. The moisture-curable polyurethane prepolymer of claim 134, wherein the layered double oxide particles are produced by calcining layered double hydroxides having a chemical formula of [M^{z+}₁₋ₓM^{′y+}ₓ(OH)₂]^{a+}(Xⁿ⁻)_{a/n} bH₂0
where M and M′ are charged metal cations and M is different from M′;
z=1 or 2 or mixture thereof;
y=3 or 4;
0<x<0.9;
b=0-10; and
Xⁿ⁻ is an anion with n>0.

141. The moisture-curable polyurethane prepolymer of claim 140, wherein M^{z+} is selected from Mg²⁺, Zn²⁺, Li^{1+′} ′ and mixtures thereof, and M^{′y+} is Al³⁺.

142. The moisture-curable polyurethane prepolymer of claim 141, wherein M^{z+} is Mg², wherein the molar ratio of Mg²⁺ to Al³⁺ is less than 2:1.

143. The moisture-curable polyurethane prepolymer of claim 141, wherein M^{z+} is Mg², and the molar ratio of Mg²⁺ to Al³⁺ is from 2.8:1 to 3.2:1.

144. The moisture-curable polyurethane prepolymer of claim 141, wherein M^{z+} is Mg², and the molar ratio of Mg²⁺ to Al³⁺ is from 3.8:1 to 4.2:1.

145. The moisture-curable polyurethane prepolymer of claim 134, wherein the layered double oxide particles have an average primary particle size of less than 1 μm.

146. The moisture-curable polyurethane prepolymer of claim 134, wherein the layered double oxide particles have a BET surface area of at least 100 m²/g.

147. The moisture-curable polyurethane prepolymer of claim 134, wherein the layered double oxide particles possess a CO₂ capture capacity.

148. The moisture-curable polyurethane prepolymer of claim 147, wherein the CO₂ capture capacity of the layered double oxide particles is directly proportional to a number of Mg²⁺ ions in the layered double oxide particles, the CO₂ capture capacity of the layered double oxide particles is directly proportional to calcination temperature the layered double hydroxide particles undergo to produce the layered double oxide particles, and/or the CO₂ capture capacity of the layered double oxide particles is directly proportional to a number of Li⁺ ions in the layered double oxide particles.

149. The moisture-curable polyurethane prepolymer of claim 134 further comprising free [NCO⁻] from 2% to 5% by weight.

150. The moisture-curable polyurethane prepolymer of claim 134, wherein the layered double oxide particles have a chemical formula of [M^{z+}₁₋ₓM^{′y+}ₓO]^{x+}Xⁿ⁻_{x/n}, where
M and M′ are charged metal cations and M is different from M′;
Xⁿ⁻ is an anion;
z=1 or 2 or a mixture thereof;
y=3 or 4; and
0<x<0.9.

151. A polyurethane product made by cross-linking a moisture-curable polyurethane hot-melt prepolymer, the polyurethane product selected from one of a sealant, an automotive product, a coating, a glazing adhesive or a semi-structural adhesive, wherein the moisture-curable polyurethane hot-melt prepolymer comprises 0.5% to 40% by weight of layered double oxide particles dispersed in the prepolymer.

152. The polyurethane product of claim 151, wherein the layered double oxide particles have a chemical formula of [M^{z+}₁₋ₓM^{′y+}ₓO]^{x+}Xⁿ⁻_{x/n}, where
M and M′ are charged metal cations and M is different from M′;
Xⁿ⁻ is an anion;
z=1 or 2 or a mixture thereof;
y=3 or 4; and
0<x<0.9.

153. The polyurethane product of claim 152, wherein M^{z+} is selected from Mg²⁺, Zn²⁺, Li¹⁺, and mixtures thereof and M^{′y+} is Al³⁺.
